(19) United States
(12) Patent Application Publication
(10) Pub. No.: US 2023/0031226 A1
(43) Pub. Date: Feb. 2, 2023

(54) METHOD FOR PROCESSING DEEP LEARNING TASK IN HETEROGENEOUS ACCELERATORS AND CLUSTER SYSTEM FOR PERFORMING THE METHOD

(71) Applicant: MOREH CORP., Seoul (KR)

(72) Inventors: Jaejin Lee, Seoul (KR); Jungho Park, Seoul (KR); Youngdong Do, Seoul (KR)

(21) Appl. No.: 17/964,626

(22) Filed: Oct. 12, 2022

Related U.S. Application Data
(63) Continuation of application No. PCT/KR2020/005120, filed on Apr. 16, 2020.

(30) Foreign Application Priority Data
Apr. 14, 2020 (KR) 10-2020-0045556

(51) Int. Cl. G06N 3/08

(52) U.S. Cl. CPC G06N 3/08

(57) ABSTRACT

Provided is a method for processing a deep learning task through a deep learning framework. The method may include executing, by a computing device, a deep learning task on a deep learning framework, determining at least one of a primary accelerator or a secondary accelerator to execute the deep learning task, allocating the deep learning task to at least one of the determined primary accelerator or secondary accelerator, and generating, based on a result processed by at least one of the determined primary accelerator or secondary accelerator, result data for the deep learning task. The secondary accelerator may be an accelerator heterogeneous to the primary accelerator.

### CROSS-REFERENCE TO RELATED APPLICATION

This application is a continuation of International Patent Application No. PCT/KR2020/005120, filed on Apr. 16, 2020, which is based upon and claims the benefit of priority to Korean Patent Application No. 10-2020-0045556, filed on Apr. 14, 2020. The disclosures of the above-listed applications are hereby incorporated by reference herein in their entirety.

### TECHNICAL FIELD

The present disclosure relates to a method for processing a deep learning task in heterogeneous accelerators and a computer program and a cluster system for performing such a method. One or more examples of the disclosure relate to a method, a computer program, and a cluster system for processing deep learning tasks in heterogeneous accelerators, capable of enhancing process efficiency for the deep learning tasks by maximizing the performance of each node.

### BACKGROUND

A deep learning framework is a package of software created to facilitate the creation and execution of deep learning applications, and the commonly used deep learning frameworks include TensorFlow and PyTorch, for example. These frameworks can both be written in the Python language, and deep learning tasks can be handled mainly by using deep learning libraries.

The deep learning library may refer to software that provides operations necessary for deep learning tasks in the form of functions, and may be mainly provided by the accelerator manufacturers. The deep learning framework supports one or more libraries (e.g., cuDNN library of NVIDIA Corporation through GPU of NVIDIA Corporation or MiOpen library of AMD Inc., etc.). The cuDNN library of NVIDIA Corporation has excellent performance and stability, and is used by many users. In addition, users mainly use cuDNN library of NVIDIA Corporation to prevent driver licensing problems, and when using cuDNN library of NVIDIA Corporation. GPU of NVIDIA Corporation, which is more expensive than other CPUs, may be used to provide deep learning cloud services through data centers. For this reason, there is a problem in that the cost of building a cluster for the deep learning cloud service is inevitably much higher than the cost of building a general cluster.

### SUMMARY

In order to address one or more problems (e.g., the problems described above and/or other problems not explicitly described herein), the present disclosure provides a method for processing a deep learning task in heterogeneous accelerators and a computer program stored in a recording medium.

The present disclosure may be implemented in various ways, including a method, an apparatus, a system, a computer program, or a computer readable storage medium storing instructions, for example, for processing a deep learning task through a deep learning framework in heterogeneous accelerators in a cluster system for a deep learning cloud service.

A method may include executing, by a computing device, a deep learning task on a deep learning framework, determining at least one accelerator of a plurality of accelerators to execute the deep learning task, allocating the deep learning task to the determined at least one accelerator, and generating, based on a result processed by the determined at least one accelerator, result data for the deep learning task. The plurality of accelerators may include at least one primary accelerator and at least one secondary accelerator that may be heterogeneous to the at least one primary accelerator.

The determining may include determining, from among the at least one primary accelerator and the at least one secondary accelerator, an accelerator to execute the deep learning task. The accelerator to execute the deep learning task may be associated with a fastest expected response time of the deep learning task.

The determining may include determining whether the deep learning task is executable on the at least one secondary accelerator, and based on the deep learning task being executable on the at least one secondary accelerator, determining, from among the at least one secondary accelerator, an accelerator to process the deep learning task by selecting at least one of: a secondary accelerator included in a first node executing the deep learning framework; or a secondary accelerator included in a second node connected to the first node through a network.

The determining an accelerator to process the deep learning task may be based on a response time of the deep learning task.

The determining an accelerator to process the deep learning task may include, based on an expected execution time of the deep learning task being shorter than a predetermined time, determining the secondary accelerator included in the first node to be the accelerator to process the deep learning task.

The determining an accelerator to process the deep learning task may include, based on an expected throughput of the deep learning task being equal to or less than a predetermined throughput, determining the secondary accelerator included in the first node to be the accelerator to process the deep learning task.

The secondary accelerator included in the second node may include a plurality of secondary accelerators included in the second node, and the determining an accelerator to process the deep learning task may include, based on an expected parameter of the deep learning task satisfying a threshold, dividing the deep learning task into a plurality of partial deep learning tasks, and determining at least two of the plurality of secondary accelerators included in the second node to be accelerators to process the plurality of partial deep learning tasks.

The dividing the deep learning task into a plurality of partial deep learning tasks may include at least one of: based on an expected throughput of the deep learning task being equal to or greater than a predetermined throughput, dividing the deep learning task into the plurality of partial deep learning tasks, or based on an expected execution time of the deep learning task being equal to or longer than a predetermined time, dividing the deep learning task into the plurality of partial deep learning tasks.

The allocating the deep learning task may include providing the plurality of partial deep learning tasks to a scheduler that manages a plurality of secondary accelerators included in the second node, selecting, by the scheduler, one or more executable secondary accelerators from among the plurality of secondary accelerators included in the second node, and allocating, by the scheduler, the plurality of partial deep learning tasks to the selected one or more executable secondary accelerators.

The dividing the deep learning task into a plurality of partial deep learning tasks may include dividing input data of the deep learning task into a plurality of partial input data sets, and the allocating the plurality of partial deep learning tasks to the selected one or more secondary accelerators may include allocating a function of the deep learning task and each of the plurality of partial input data sets to the selected one or more executable secondary accelerators.

The dividing the deep learning task into a plurality of partial deep learning tasks may include dividing parameter data of the deep learning task into a plurality of partial parameter data sets, and the allocating the plurality of partial deep learning tasks to the selected one or more executable secondary accelerators may include allocating a function of the deep learning task and each of the plurality of partial parameter data sets to the selected one or more executable secondary accelerators.

The method may further include, prior to the determining at least one of the plurality of accelerators to execute the deep learning task, determining that an operation of the deep learning task requires a plurality of accelerators, and based on the operation of the deep learning task requiring a plurality of accelerators and based on a quantity of accelerators allocated to a first node executing the deep learning framework being less than a quantity of the required plurality of accelerators, scheduling at least a portion of the deep learning task for execution on at least one of the accelerators allocated to the first node. The deep learning task may include scheduling information for the deep learning task scheduled to be executed on the at least one of the accelerators allocated to the first node.

There is provided a computer program stored in a computer-readable recording medium for executing, on a computer, a method for processing a deep learning task through a deep learning framework in heterogeneous accelerators in a cluster system for a deep learning cloud service, described above.

According to some examples of the present disclosure, it is possible to determine an accelerator to execute the deep learning task based on the response time and/or throughput from the input data of the deep learning task and the amount of computation required therefor, and execute and/or process the deep learning task using the determined accelerator, thereby maximizing utilization of the performance of each node, and thus increasing process efficiency for the deep learning task requested by a user.

According to some examples of the present disclosure, by concurrently performing deep learning tasks using multiple nodes through parallelization of deep learning tasks, even when the memory size of the secondary accelerator is less than the size of the virtual accelerator provided and available to the user, the memory size limitation can be overcome through the parallelization operation.

According to some examples of the present disclosure, the offloader offloads a plurality of divided partial deep learning tasks to a plurality of secondary accelerators, selects an idle secondary accelerator through the scheduler and requests to execute the offloaded task to process the deep learning task, such that it is possible to improve the performance and power efficiency of cluster system for deep learning cloud service.

The advantageous effects of the present disclosure are not limited to the effects described above, and other advantageous effects that are not mentioned above can be clearly understood to those skilled in the art based on the description provided below.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a schematic diagram illustrating a configuration in which a plurality of first nodes and a plurality of second nodes are communicatively connected to each other in order to provide a method for processing a deep learning task through a deep learning framework in heterogeneous accelerators in a cluster system for a deep learning cloud service;

FIG. 2 is a block diagram illustrating internal configurations of a plurality of first nodes and a plurality of second nodes;

FIG. 3 is a block diagram illustrating an internal configuration of a processor of the first node;

FIG. 4 is a block diagram provided to illustrate a process performed by secondary accelerators of a plurality of second nodes when a deep learning task is executed in the first nodes;

FIG. 5 is a schematic diagram illustrating a cluster system for a deep learning cloud service:

FIG. 6 is a flowchart illustrating a method for processing a deep learning task in heterogeneous accelerators;

FIG. 7 is a flowchart illustrating a method for determining at least one of a primary accelerator or a secondary accelerator, and

FIG. 8 is a flowchart illustrating a method for determining at least one of a primary accelerator or a secondary accelerator.

### DETAILED DESCRIPTION

Hereinafter, examples details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of various examples, duplicate descriptions of the same or corresponding components may be omitted. However, even if descriptions of components are omitted, it is not intended that such components are not included in any embodiment.

Advantages and features of the disclosed examples and methods of accomplishing the same will be apparent by referring to examples described below in connection with the accompanying drawings. However, the present disclosure is not limited to the examples disclosed below, and may be implemented in various different forms, and the examples are merely provided to make the present disclosure complete, and to fully disclose the scope of the disclosure to those skilled in the art to which the present disclosure pertains.

The terms used herein will be briefly described prior to describing the disclosed embodiment(s) in detail. The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the embodiment(s). Therefore, the terms used in the present disclosure should be defined based on the meaning of the terms and the overall content of the present disclosure rather than a simple name of each of the terms.

As used herein, the singular forms “a.” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, segments of program code, drivers, firmware, micro-codes, circuits, data, database, data structures, tables, arrays, or variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, the “cluster system” may include a plurality of nodes (e.g., computers) connected through a network. Under such a client system, the client device can use the cluster system as one single computer. Since such a cluster system provides connected users with a plurality of computers to use as one computer, thereby implementing much improved processing speed than that of one computer.

In the present disclosure, the “primary accelerator” may refer to an accelerator mainly used in a deep learning framework to ensure the feasibility of the deep learning framework. For example, the primary accelerator may refer to a high-performance and high-cost GPU of NVIDIA Corporation for providing a deep learning cloud service.

In the present disclosure, the “secondary accelerator” may refer to a heterogeneous accelerator, that is, an accelerator different from the primary accelerator. For example, the secondary accelerator may be any accelerator that has a lower cost than the primary accelerator. Alternatively, the secondary accelerator may refer to an accelerator of the same type as the primary accelerator.

In the present disclosure, “expected response time” may refer to a time including an expected execution time and an expected network time when executing a deep learning task on each accelerator (e.g., the primary accelerator and the secondary accelerator included in each of the first nodes, and the secondary accelerator included in each of the second nodes) included in the cluster system for deep learning cloud service.

In the present disclosure, “expected throughput” may refer to a throughput that is expected when executing a deep learning task on each accelerator (e.g., the primary accelerator and the secondary accelerator included in each of the first nodes, and the secondary accelerator included in each of the second nodes) included in the cluster system for a deep learning cloud service.

In the present disclosure, the “expected execution time” may refer to time that is expected to take when executing a deep learning task on each accelerator (e.g., the primary accelerator and the secondary accelerator included in each of the first nodes, and the secondary accelerator included in each of the second nodes) included in the cluster system for a deep learning cloud service.

In the present disclosure. “n” may refer to a natural number equal to or greater than 1, “m” may refer to a natural number equal to or greater than 1, and “n” and “m” may be the same numerical value or different numerical values. When the reference number of a component in each drawing is designated as “n”, the “n” may be allocated different natural numbers depending on each configuration. Likewise, when the reference number of a component in each drawing is designated as “m”, the “m” may be allocated different natural numbers depending on each component.

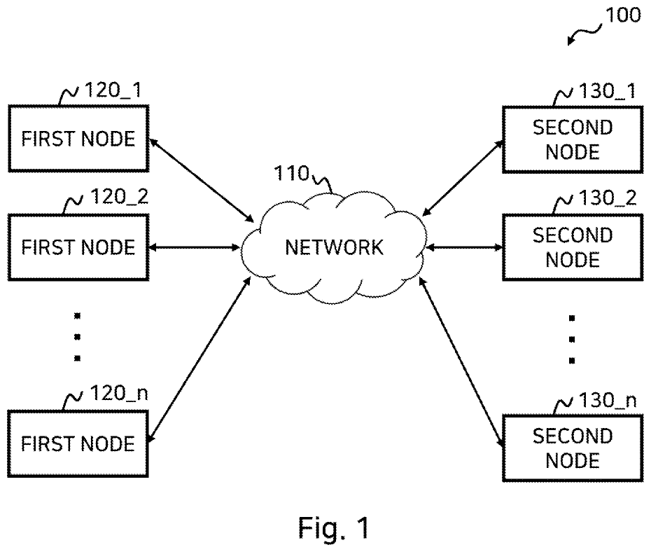

FIG. 1 is a schematic diagram illustrating a configuration in which a plurality of first nodes 120_1 to 120_n and a plurality of second nodes 130_1 to 130_n are communicatively connected to each other in order to provide a method for processing a deep learning task through a deep learning framework in heterogeneous accelerators in a cluster system 100 for a deep learning cloud service. The cluster system 100 for a deep learning cloud service may be configured to provide a cluster environment for a deep learning cloud service capable of executing a deep learning application or program. The cluster system 100 may be configured to include the plurality of first nodes 120_1 to 120_n and the plurality of second nodes 130_1 to 130_n. For example, as illustrated in FIG. 1, the cluster system 100 may include the plurality of first nodes 120_1 to 120_n and the plurality of second nodes 130_1 to 130_n. In this case, the first nodes 120_1 to 120_n may be front nodes as the environment provided to users through a deep learning framework for the deep learning cloud service, and the second nodes 130_1 to 130_n may be back nodes as the environment for processing deep learning tasks offloaded from the first nodes (e.g., front nodes).

Each of the first nodes 120_1 to 120_n and the second nodes 130_1 to 130_n may be configured to include a computing device including one or more accelerators. In this example, the accelerator may be a GPU, an FPGA, a DSP, an Intel Xeon Phi, a TPU, an NPU, a multi-core CPU, or the like, for example, but is not limited thereto.

A network 110 may be configured to enable communication between the plurality of first nodes 120_1 to 120_n and the plurality of second nodes 130_1 to 130_n included in the cluster system 100. The network 110 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. In other words, the communication method is not limited, and include not only a communication method utilizing a communication network (e.g., mobile communication network, wired Internet, wireless Internet, broadcasting network, satellite network, and the like) that the network 110 may include, but also short-range wireless communication between the plurality of first nodes 120_1 to 120_n and the plurality of second nodes 130_1 to 130_n. For example, the network 110 may include any one or more of networks including a personal area network (PAN), a local area network (LAN), a campus area network (CAN), a metropolitan area network (MAN), a wide area network (WAN), a broadband network (BBN), the Internet, and the like. In addition, the network 110 may include any one or more of network topologies including a bus network, a star network, a ring network, a mesh network, a star-bus network, a tree or hierarchical network, and the like, but not limited thereto.

The plurality of first nodes 120_1 to 120_n and the plurality of second nodes 130_1 to 130_n may perform information processing and communication on the cluster system 100, and be configured in the form of terminals such as computing devices or remote processing devices. In addition, while each of the first nodes 120_1 to 120_n and the second nodes 130_1 to 130_n may independently perform information processing, and the like, they may also exchange data with respective nodes through the network 110 or perform information processing or the like while cooperating with a plurality of other nodes through parallel programming.

The first nodes 120_1 to 120_n and the second nodes 130_1 to 130_n may perform communication for the operation of the deep learning application. For example, the first nodes 120_1 to 120_n may control the operations of a plurality of accelerators included in the second nodes 130_1 to 130_n through the deep learning framework to process the deep learning task. The plurality of first nodes 120_1 to 120_n and the plurality of second nodes 130_1 to 130_n may correspond to any one of a transmission source, a destination, or a relay point of data.

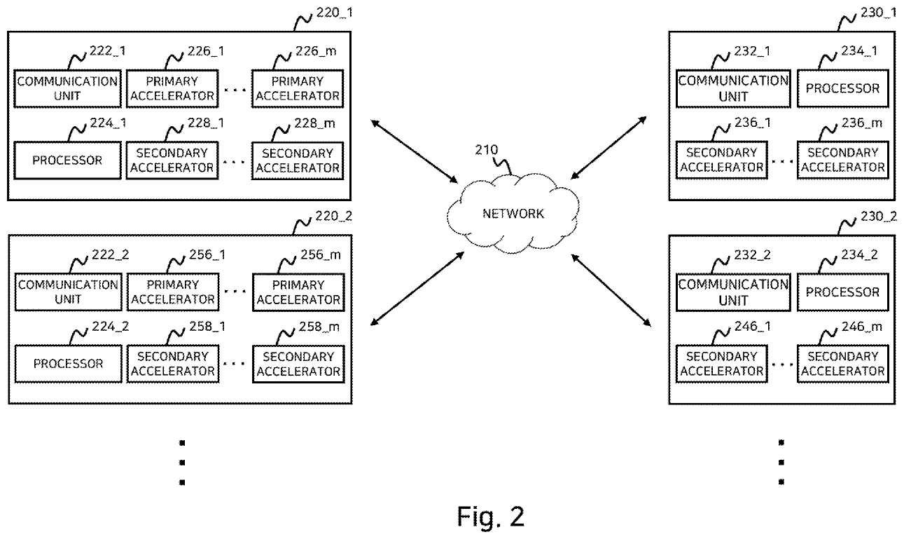

FIG. 2 is a block diagram illustrating internal configurations of a plurality of first node(s) 220_1 and 220_2 and a plurality of second node(s) 230_1 and 230_2. While FIG. 2 illustrates the first node and the second node as two nodes, respectively, aspects are not limited thereto, and there may be three or more nodes. In addition, the number of the first nodes and the number of the second nodes may be the same or different from each other.

As illustrated, the first nodes 220_1 and 220_2 may be configured to include communication units 222_1 and 2222, processors 224_1 and 224_2, primary accelerators 226_1 to 226_m and 256_1 to 256_m, and secondary accelerators 228_1 to 226_m and 256_1 to 256_m. One first node (e.g., 220_1) may include one or more primary accelerators 226_1 to 226_m and one or more secondary accelerators 228_1 to 228_m. Alternatively, one first node may include one or more primary accelerators only.

Each primary accelerator of the first nodes 220_1 and 220_2 may be a high-performance accelerator that provides a deep learning library, and the secondary accelerator may be an accelerator heterogeneous to the primary accelerator. For example, the primary accelerator may be a high-performance and high-cost GPU of NVIDIA Corporation for providing a deep learning cloud service, and the secondary accelerator may be any accelerator that is different from the primary accelerator and has a lower cost than the primary accelerator.

The primary accelerator and the secondary accelerator included in the first node may be configured in various combinations according to implementation examples so as to have an environment capable of providing users with a deep learning framework for a deep learning cloud service. In addition, each of the plurality of first nodes 220_1 and 220_2 may be configured to include a different number of primary accelerators and secondary accelerators.

The second nodes 230_1 and 230_2 may be configured to include communication units 232_1 and 232_2, processors 234_1 and 2342, and secondary accelerators 236_1 to 236_m and 246_1 to 246_m. One second node (e.g., 230_1) may include one or more secondary accelerators 236_1 to 236_m. In this case, the secondary accelerators 236_1 to 236_m are accelerators heterogeneous to the primary accelerator included in the first node, and may execute an offloaded deep learning task.

In addition, the secondary accelerator included in each of the second nodes may be built using an accelerator of lower cost than the primary accelerator in order to reduce the cost of building a cluster for the deep learning cloud service. For example, if the primary accelerator is an accelerator provided by NVIDIA Corporation (or any other accelerator), the secondary accelerator may be any accelerator different from the accelerator used as the primary accelerator such as, GPU. FPGA, DSP, TPU, NPU, multi-core CPU, and the like, but is not limited thereto. Each of the plurality of second nodes may be configured to include different numbers and/or types of secondary accelerators.

Each of the processors 224_1 and 224_2 of the first nodes 220_1 and 220_2 and the processors 234_1 and 234_2 of the second nodes 230_1 and 230_2 may be configured as a general-purpose processor for arithmetic processing such as a central processing unit (CPU), for example, and may be connected to one or more accelerators included in each node to control the operation of the accelerator. In addition, the processor may be connected to a main memory (not illustrated) included in each node. For example, the processor may be connected to a plurality of accelerators and/or main memories through a peripheral Component Interconnect-Express (PCI-E) bus, and may transmit and receive data for controlling the plurality of accelerators and/or main memories.

Each of the first nodes 220_1 and 220_2 and the second nodes 230_1 and 2302 may use a network 210 through a communication unit for communicating with different nodes to perform communication for the operation of the deep learning application. In this case, the network 210 may represent the same or similar network to the network 110 of FIG. 1. For example, the plurality of first nodes 220_1 and 220_2 and the plurality of second nodes 230_1 and 230_2 are connected by a high-performance network switch such that one of the plurality of first nodes 220_1 and 220_2 may allocate the accelerator library function and input data to the plurality of second nodes 230_1 and 230_2 using the network 210 through the communication unit.

The processors 234_1 to 234_n of the plurality of second nodes 230_1 and 230_2 allocated with the accelerator library function and input data may control the operations of one or more secondary accelerators 236_1 to 236_n included in each of the second nodes 230_1 and 230_2 to process the deep learning task, and transmit the result data to the first node requesting the deep learning task through the network 210.

The processors 224_1 and 224_2 of the first nodes 220_1 and 2202 may receive intermediate result data for processing the accelerator library function from each of the second nodes 230_1 and 230_2, the primary accelerator and/or the secondary accelerator of the first node through the communication units 222_1 and 222_2, and may generate result data for the called accelerator library function based on the received intermediate result data. The processor of the first node may receive the intermediate result data processed by the accelerators of the first nodes and/or the second nodes, and concatenate the received intermediate result data to generate the result data. For example, in the case of a convolution function among the accelerator library functions provided by CuDNN, result data may be generated by concatenating intermediate result data received from a plurality of accelerators. According to another example, the processor of the first node may receive the intermediate result data processed by the accelerators of the first nodes and/or the second nodes, and calculate and process the received intermediate result data to generate the result data. This process may be referred to as reduction. For example, in the case of the MaxPooling function among the accelerator library functions provided by CuDNN, result data may be generated by calculating and processing intermediate result data received from a plurality of accelerators included in the first nodes and/or the second nodes.

While it is described above in FIG. 2 that the secondary accelerator may be the accelerator heterogeneous to the primary accelerator, aspects are not limited thereto. For example, the secondary accelerator may be a homogeneous accelerator as the primary accelerator.

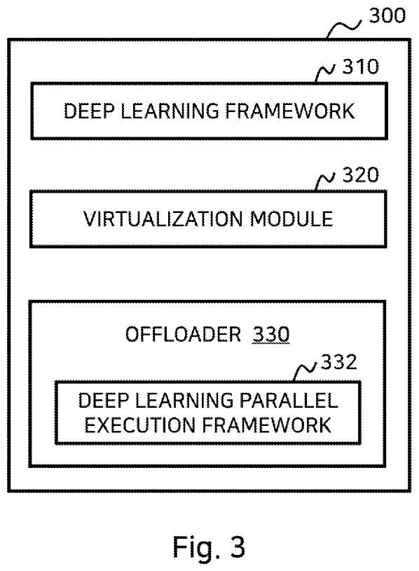

FIG. 3 is a block diagram illustrating an internal configuration of a processor 300 of a first node. The processor 300 of the first node may include a deep learning framework 310, a virtualization module 320, and an offloader 330. As illustrated, the deep learning framework 310, the virtualization module 320, and the offloader 330 may be operated by, or processed on the processor 300.

The deep learning framework 310 may include a software assembly configured to facilitate writing and/or executing of a deep learning application, in order to provide a deep learning cloud environment to the user through the deep learning library and various deep learning algorithms. The deep learning framework 310 may include a DNN framework. The DNN framework may apply a deep learning process or deep learning operation function to an accelerator to accelerate training and/or inference processes, so that developers can more easily use parallel programming models or programs that require high proficiency. For example, the DNN framework may include DNN frameworks such as Caffe, Tensorflow, Pytorch, CNTK, Theano, and the like, which have been widely used recently, but is not limited thereto.

The virtualization module 320 may be configured to virtualize an accelerator included in a cluster system for a deep learning cloud service. The virtualization module 320 may virtualize a plurality of accelerators (e.g., accelerators included in each of the plurality of second nodes) to be viewed as one single virtual accelerator for user convenience when writing and/or modifying a program, and may provide the single virtualized virtual accelerator to the user. Since the users can write and/or modify a program for the single virtual accelerator provided from the virtualization module without having to consider a large number of accelerators included in the cluster system for deep learning cloud service, it may be possible to reduce the time taken to build or modify the program, and further simplify the algorithm of the program. When executing and/or processing a program written for one virtual accelerator (e.g., a deep learning task), the deep learning task may be directly provided to the offloader 330 to process the corresponding task, and may be distributed by one or more of a plurality of accelerators included in the deep learning cloud service cluster system and executed.

If a deep learning application is executed on one first node and a command for the corresponding node is received, the virtualization module 320 may determine whether or not a plurality of accelerators are required for the operation of the received deep learning task, and virtualize the accelerators included in the corresponding first node and/or the plurality of second nodes based on the corresponding command. For example, if the operation of the deep learning task requires a plurality of accelerators (e.g., a high-performance deep learning task that requires a large number of accelerators), if the number of accelerators allocated to the first node executing the deep learning framework is less than a required number of a plurality of accelerators, the virtualization module 320 may virtualize the accelerator allocated to the first nodes to be viewed as a plurality of virtual accelerators, and may allocate the virtualized plurality of virtual accelerators to the first node. In this case, the virtualization module 320 may schedule a deep learning task for execution in at least some of the allocated accelerators, and then provide the corresponding deep learning task to the offloader 330.

The corresponding task may be provided to the offloader 330 and normally processed by at least some of the allocated accelerators. In this case, the deep learning task may include information scheduled by the virtualization module 320 so as to be executed in at least some of the allocated accelerators (e.g., a plurality of accelerators of the second node). The accelerator virtualized by the virtualization module 320 may execute a deep learning task on the deep learning framework 310. That is, the virtualization module 320 may virtualize the accelerators included in the node to implement it as if another node includes the virtualized accelerators.

The offloader 330 may be configured to determine at least one of the primary accelerator or the secondary accelerator to execute the deep learning task provided from the virtualization module 320. The offloader 330 may determine an accelerator having the fastest expected response time of the deep learning task, among the accelerators included in the cluster system for a deep learning cloud service, to be the accelerator to execute the corresponding deep learning task. When executing the corresponding deep learning task on each accelerator of the primary accelerator included in the first node, the secondary accelerator included in the first node, and the secondary accelerator included in the second node, that is, when executing the corresponding deep learning task in the primary and secondary accelerators of the first node, and the secondary accelerators of the second node, the offloader 330 may determine at least some of the accelerators with the faster expected response time than a predetermined time to be the accelerators to process the corresponding deep learning task.

If the deep learning task provided from the virtualization module 320 can be executed only in the primary accelerator of the first node, the offloader 330 may determine the primary accelerator of the first node to be the accelerator to process the deep learning task. On the other hand, if the deep learning task is executable in the secondary accelerator, or if the deep learning task is executable only in the secondary accelerator, the offloader 330 may determine one of the secondary accelerator included in the first node or the secondary accelerator included in the second node executing the deep learning framework to be the accelerator to process the deep learning task.

The offloader 330 may determine at least one of the secondary accelerator included in the first node or the secondary accelerator included in the second node to be the accelerator to process the deep learning task based on the response time. For example, if the response time of the deep learning task is important (e.g., a deep learning task with the response time associated with a critical inference process, and the like), the offloader 330 may determine at least some of the secondary accelerators included in the first node to be the accelerators to process the deep learning task, and if the response time of the deep learning task is relatively not important (e.g., a deep learning task associated with a training process, and the like), the offloader 330 may determine at least some of the secondary accelerators included in the second node to be the accelerators to process the deep learning task.

The offloader 330 may determine at least one of the secondary accelerator included in the first node or the secondary accelerator included in the second node to be the accelerator to process the deep learning task based on stability and/or priority. For example, the offloader 330 may compare the performance of the secondary accelerator included in the first node or the secondary accelerator included in the second node, and based on the comparison result, for a deep learning task of which stability is relatively important and/or which has high priority compared to the other deep learning tasks, the offloader 330 may determine at least some of the secondary accelerators with high performance (e.g., newer accelerators) to be the accelerators to process the deep learning task. On the other hand, for a deep learning task of which stability is relatively not important and/or which has low priority, at least some of secondary accelerators with relatively low performance may be determined to be the accelerators to process the deep learning task.

The offloader 330 may determine at least one of the secondary accelerator included in the first node or the secondary accelerator included in the second node to be the accelerator to process the deep learning task based on the expected execution time and/or the expected throughput of the deep learning task. If the expected execution time of the requested deep learning task is shorter than a predetermined time, and/or the expected throughput of the deep learning task is equal to or less than a predetermined throughput, the secondary accelerator included in the first node may be determined to be the accelerator to process the deep learning task. For example, if a deep learning task is associated with an inference process for which response time is important, the expected execution time of the corresponding deep learning task may be shorter than a predetermined time. In this case, the offloader 330 may determine the secondary accelerator included in the first node to be the accelerator to process the deep learning task, so as to minimize the response time of the corresponding deep learning task.

On the other hand, if the expected execution time of the requested deep learning task is longer than the predetermined time, and/or the expected throughput of the deep learning task is equal to or greater than the predetermined throughput, the offloader 330 may determine the plurality of secondary accelerators included in the second node to be the accelerators to process the deep learning task. For example, if the deep learning task is associated with a training process with a large amount of computations, the expected throughput of the corresponding deep learning task may be greater than the predetermined throughput. In this case, the offloader 330 may determine one or more of the secondary accelerators included in the second node to be the accelerators to process the deep learning task.

The offloader 330 may include a deep learning parallel execution framework 332. If the offloader 330 determines at least one of the secondary accelerators included in the second node to be the accelerator to process a deep learning task, the deep learning parallel execution framework 332 may compare the throughput of the deep learning task with a predetermined throughput. As a result of the comparison, if the throughput of the deep learning task is equal to or greater than the predetermined throughput, the deep learning parallel execution framework 332 may divide the deep learning task into a plurality of partial deep learning tasks, and determine at least some of the plurality of secondary accelerators included in each of the second nodes to be the accelerators to process the plurality of partial deep learning tasks.

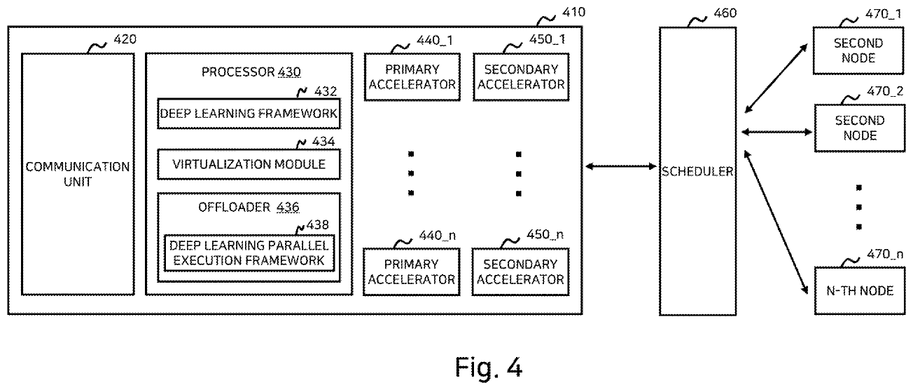

That is, the deep learning parallel execution framework 332 may divide a task with a higher parallelism among the deep learning tasks into a plurality of partial deep learning tasks and distribute the tasks so that the tasks are processed in parallel by a plurality of heterogeneous accelerators (that is, by a plurality of secondary accelerators of each of the second nodes). The deep learning parallel execution framework 332 may provide data parallelism that distributes and processes the training data in a plurality of nodes, and model parallelism that distributes and processes a deep learning network in a plurality of nodes if parameters to be learned through the training process, such as weights, gradients, and the like, cannot be stored in memory at once. The process of the deep learning parallel execution framework 332 dividing the deep learning task into a plurality of partial deep learning tasks and processing a plurality of divided partial deep learning tasks, if the throughput of the deep learning task is equal to or greater than the predetermined throughput, will be described in detail below with reference to FIG. 4.

As described above, the offloader 330 may determine an accelerator to execute the deep learning task based on the response time and/or throughput from the input data of the deep learning task and the required amount of operation. Since the deep learning task is executed and/or processed using the accelerators determined as described above, utilization of the performance of each node can be maximized, thus enhancing the process efficiency of the deep learning task requested by the user. In addition, by concurrently performing deep learning tasks using a plurality of second nodes through parallelization of the deep learning tasks, even if the size of the accelerator provided to the user is smaller than the size of memory required for the deep learning task, the limit of memory size can be overcome through the corresponding parallelization task.

FIG. 4 is a block diagram illustrating an example where a deep learning task is executed in a first node 410, in which the secondary accelerators of a plurality of second nodes 470_1 to 470_n process the task. Hereinafter, only one first node 410 is illustrated in FIG. 4 for convenience of explanation, but aspects are not limited thereto, and any first node included in the cluster system for the deep learning cloud service may communicate with a plurality of second nodes through the network to process the deep learning task. If the deep learning task is executed on a deep learning framework 432 by the user, a processor 430 of the first node 410 may call a deep learning-related function (e.g., a deep learning operation function). If the deep learning-related function is called, a virtualization module 434 and/or an offloader 436 may intercept the called deep learning-related function.

The virtualization module 434 may determine whether or not the operation of the deep learning task requires a plurality of virtual accelerators based on the intercepted deep learning-related function. That is, if it is determined that the deep learning task is a task to be operated by a plurality of virtual accelerators, the virtualization module 434 may schedule such that the tasks allocated to each of the accelerators are executed on a small number of any real accelerators, and provide the scheduled tasks to the offloader 436. If the deep learning task can be operated on a single accelerator, the virtualization module 434 may provide the deep learning task to the offloader 436 without going through the scheduling process.

The offloader 436 may determine whether or not the deep learning task received from the virtualization module 434 is executable in the secondary accelerator (that is, in the heterogeneous accelerator). When determining it not to be executable in the secondary accelerator, the offloader 436 may determine at least one of the primary accelerators 440_1 to 440_n included in the first node to be the accelerator to process the deep learning task, and the deep learning task may be executed by at least one of the determined plurality of primary accelerators 440_1 to 440_n.

When determining it to be executable in the secondary accelerator, the offloader 436 may determine the nature of the deep learning task. The offloader 436 may determine a secondary accelerator to execute the deep learning task, based on at least one of the response time or the throughput required for the deep learning task. If the response time of the deep learning task is important (e.g., if the execution time is shorter than a predetermined time, and the like), the offloader 436 may determine at least one of a plurality of secondary accelerators included in the first node 410 to be the accelerators to execute the deep learning task. On the other hand, if the throughput of the deep learning task is important (e.g., when the throughput of the deep learning task is greater than or equal to a predetermined throughput), at least some of the plurality of secondary accelerators included in the second node may be determined to be the accelerators to execute the deep learning task.

If at least some of the plurality of secondary accelerators included in the second nodes 470_1 to 470_n are determined to be the accelerators to process a plurality of partial deep learning tasks, a deep learning parallel execution framework 438 of the offloader 436 may divide the deep learning task into a plurality of partial deep learning tasks. The deep learning parallel execution framework 438 may divide the input data of the deep learning task into a plurality of partial input data sets to divide the deep learning task into a plurality of partial deep learning tasks, and allocate the divided plurality of partial deep learning tasks to the determined one or more secondary accelerators. In this case, each of the function of the deep learning task and the divided plurality of partial input data sets may be allocated to one or more selected secondary accelerators.

Alternatively or additionally, the deep learning parallel execution framework 438 may divide the parameter data of the deep learning task into a plurality of partial parameter data sets to divide the deep learning task into a plurality of partial deep learning tasks, and allocate the divided plurality of partial deep learning tasks to the selected one or more secondary accelerators. In this case, each of the function of the deep learning task and the divided plurality of partial parameter data sets may be allocated to one or more selected secondary accelerators.

The cluster system for the deep learning cloud service may further include a scheduler 460. The scheduler 460 may be configured to be included in anode that is formed separately from the first node 410 and the second nodes 470_1 to 470_n and configured to communicate with the first node 410 and the second nodes 470_1 to 470_n through a network, as illustrated. In another example, the scheduler 460 may be included in at least one of the first node 410 and the second nodes 470_1 to 470_n and operated.

The scheduler 460 may be configured to manage a plurality of secondary accelerators included in the second nodes 470_1 to 470_n. The scheduler 460 may receive a plurality of partial deep learning tasks from the offloader 436, and select one or more executable secondary accelerators from among the plurality of secondary accelerators included in the second nodes 470_1 to 470_n to allocate a plurality of partial deep learning tasks thereto. At this time, the scheduler 460 may be configured to manage the execution state of the deep learning task in progress in the plurality of second nodes 470_1 to 470_n, and allocate the deep learning task (that is, a plurality of divided partial deep learning tasks) received from the offloader 436 to one or more secondary accelerators in an idle state among the secondary accelerators included in the plurality of second nodes 470_1 to 470_n. For example, if the second node available to the first node includes the first, second, and n-th second nodes 470_1, 4702, and 470_n, and some of the secondary accelerators included in each of the second nodes 470_1, 470_2, and 470_n are in the idle state, the offloader 436 may select some of the plurality of secondary accelerators in the idle state included in each of the first, second, and n-th second nodes 470_1, 470_2, and 470_n, allocate a plurality of divided partial deep learning tasks, respectively, and request each secondary accelerator to execute the corresponding task.

In addition, the scheduler 460 may check a task state of the secondary accelerator included in the second node, and provide the secondary accelerator completing executing the deep learning task with information on a destination node to receive the output data of the deep learning task. The second node (e.g., one of the plurality of second nodes) including the secondary accelerator completing executing the deep learning task may transmit the output data through the network to the first node 410 requesting the corresponding task, based on the information provided from the scheduler 460. For example, the scheduler 460 may transmit, to the second node completing the task, a request to move the output data to the memory of the first node 410, and the second node completing the task may transmit the output data through the network to the memory of the first node 410 requesting the corresponding deep learning task.

The result data for the deep learning task may be generated based on the result processed by at least one of the primary accelerator or the secondary accelerator. For example, if a deep learning task is processed in parallel through a plurality of secondary accelerators, the result data may be generated by the processes to be described in detail below.

The first node 410 requesting the corresponding deep learning task may receive the processed result data through a network from each of the plurality of secondary accelerators included in the second node, and concatenate or reduce the received result data to generate final result data. In another example, each of the second nodes may generate intermediate result data based on the result data processed from each of a plurality of secondary accelerators included in the second node, and transmit the generated intermediate result data through the network to the first node 410 requesting the corresponding deep learning task. In another example, the result data processed from each of the plurality of secondary accelerators included in the second node may be transmitted to one second node, then each result data received by one second node may be concatenated or reduced to generate final result data, and then the final result data may be transmitted through the network to the first node 410 requesting the corresponding deep learning task.

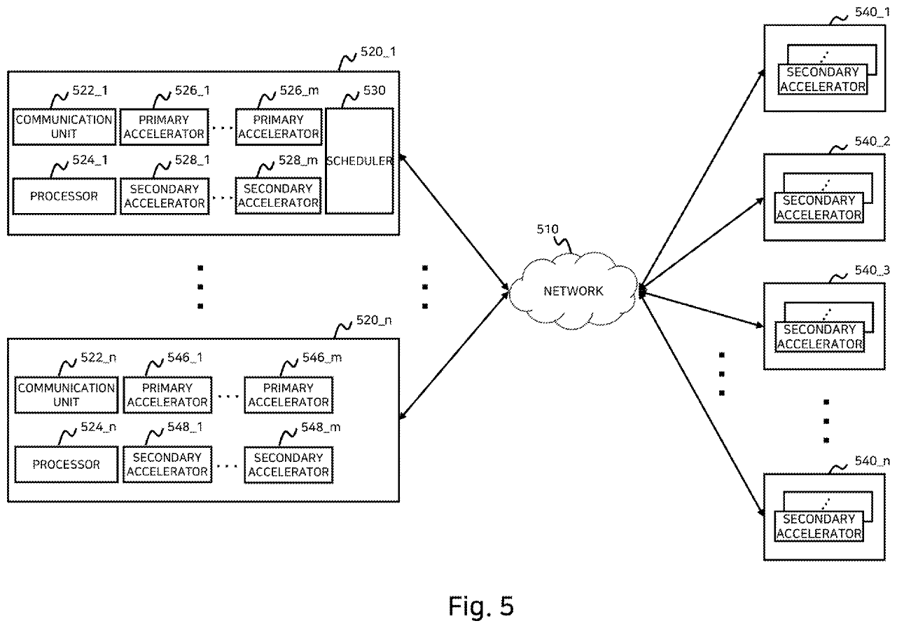

FIG. 5 is a block diagram illustrating a cluster system for a deep learning cloud service. A scheduler 530 may be configured to be included in at least one of plurality of first nodes 520_1 to 520_n. For example, the scheduler 530 may be configured to be included in one node 520_1 among a plurality of first nodes, as illustrated.

The scheduler 530 may receive the deep learning task requested from the plurality of first nodes 520_1 to 520_n through a network 510, select a secondary accelerator to execute each deep learning task from among a plurality of secondary accelerators included in a plurality of second nodes 540_1 to 540_n, and request the selected secondary accelerators to execute the deep learning task. In this case, each of the plurality of deep learning tasks may be a task executable in a plurality of secondary accelerators included in the second node.

For example, the scheduler 530 may receive deep learning tasks from the second first node (not illustrated) and the n-th first node 520_n through the network 510, respectively. In this case, each deep learning task may include a plurality of partial deep learning tasks obtained by dividing by each offloader of the second first node and the n-th first node. The scheduler 530 may check the task states of the plurality of secondary accelerators included in the plurality of second nodes 540_1 to 540_n, and select some of the secondary accelerators in the idle state, to allocate each of the plurality of partial deep learning tasks to the secondary accelerators and request each selected secondary accelerator to execute the corresponding task. In addition, the scheduler 530 may provide the secondary accelerators completing executing the task with information on a destination node to receive the output data of the deep learning task.

FIG. 5 illustrates that the scheduler is included in one node among the plurality of first nodes, but aspects are not limited thereto, and it may be included in the plurality of nodes. For example, the scheduler may be configured to be included in each of at least some of the plurality of first nodes, and each scheduler may manage a plurality of secondary accelerators included in each of the second nodes determined to be managed.

FIG. 5 illustrates that a plurality of first nodes 520_1 to 520_n include the same number and type of primary and secondary accelerators, but aspects are not limited thereto. Each of the plurality of first nodes 520_1 to 520_n may be configured to include different numbers of primary accelerators and secondary accelerators. The plurality of second nodes 540_1 to 540_n are also illustrated to include the same number and type of secondary accelerators, but aspects are not limited thereto, and each of the plurality of second nodes may also be configured to include different numbers of secondary accelerators.

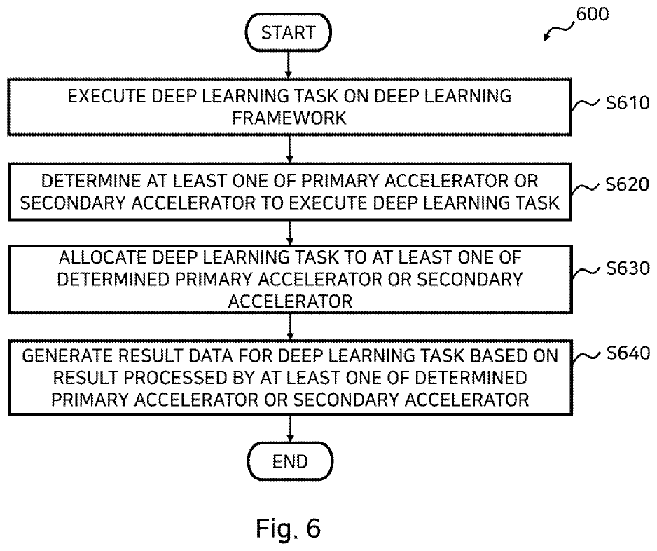

FIG. 6 is a flowchart illustrating a method 600 for processing a deep learning task through a deep learning framework in heterogeneous accelerators. The method 600 for processing a deep learning task in the heterogeneous accelerators may be performed by a cluster system for a deep learning cloud service. The method for processing a deep learning task in the heterogeneous accelerators may be initiated by executing a deep learning task on a deep learning framework (S610).

At least one of the primary accelerator or the secondary accelerator to execute the deep learning task may be determined (S620). This determination may be made by the offloader running on a processor included in the node executing the deep learning task. In this case, the secondary accelerator may be an accelerator heterogeneous to the primary accelerator.

The deep learning task may be allocated to at least one of the determined primary accelerator or the secondary accelerator (S630). The scheduler may receive a plurality of partial deep learning tasks from the offloader, and select one or more executable secondary accelerators from among a plurality of secondary accelerators included in the second node to allocate a plurality of partial deep learning tasks thereto. In this case, the scheduler may be configured to manage a plurality of secondary accelerators included in the second node.

The result data for the deep learning task may be generated based on the result processed by at least one of the determined primary accelerator or the secondary accelerator (S640). The first node requesting the corresponding deep learning task may receive the processed result data from each of the plurality of secondary accelerators included in the second node through a network, and concatenate or reduce the received result data to generate final result data.

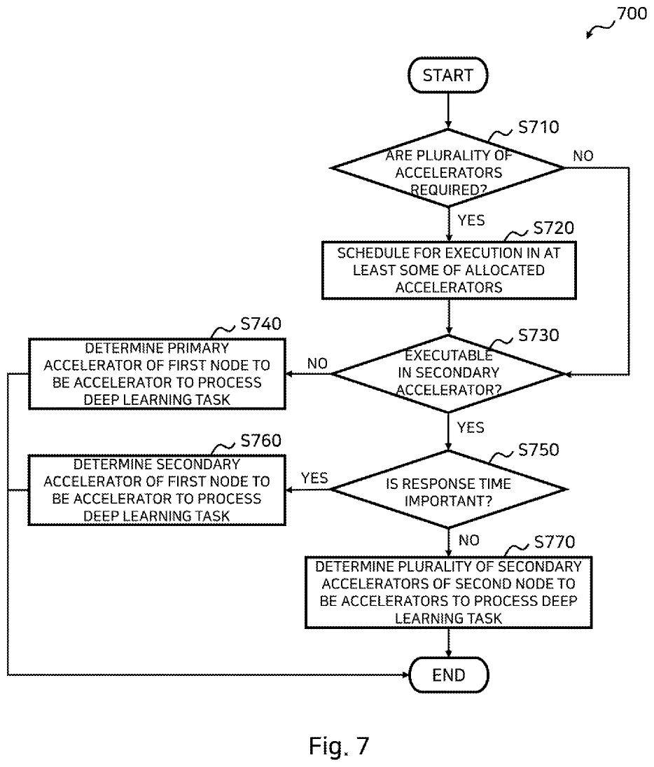

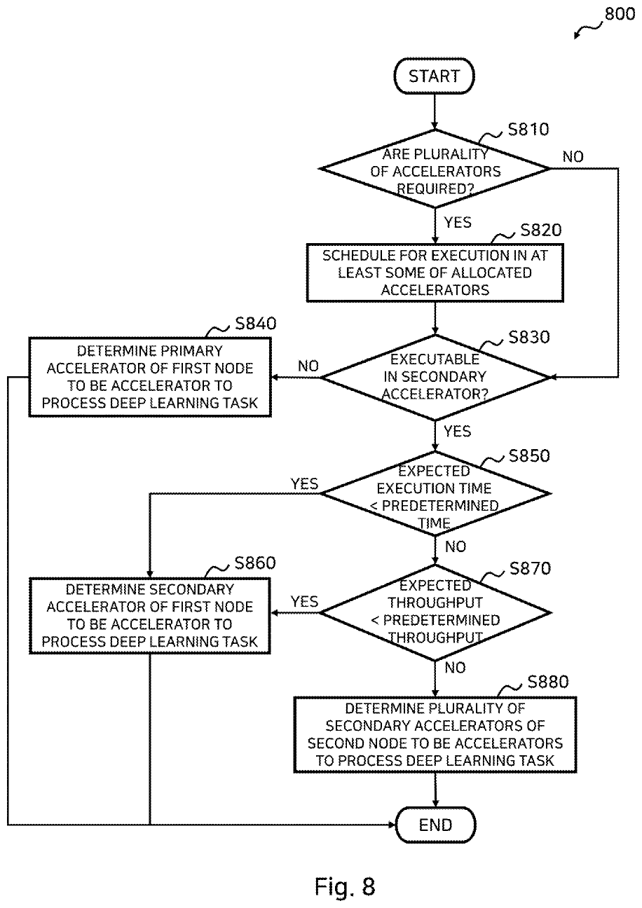

Examples of the step (S620) of determining at least one of the primary accelerator or the secondary accelerator will be described in more detail below with reference to FIGS. 7 and 8.

FIG. 7 is a flowchart illustrating a method 700 for determining at least one of the primary accelerator or the secondary accelerator. The method 700 for determining at least one of the primary accelerator or the secondary accelerator may be performed by a cluster system for a deep learning cloud service. According to the method 700 for determining at least one of the primary accelerator or the secondary accelerator, prior to determining at least one of the primary accelerator or the secondary accelerator to execute the deep learning task, a step (S710) of determining whether or not a plurality of accelerators is required for the operation of the deep learning task may be initiated.

When executable in a plurality of accelerators, scheduling may be performed so that tasks can be executed in at least some of the actually allocated accelerators (S720). For example, if the number of accelerators allocated to the first node executing the deep learning framework is less than the number of a plurality of accelerators required for the deep learning task, the processor may virtualize the accelerators allocated to the first node to be viewed as a plurality of virtual accelerators and allocate the virtualized plurality of virtual accelerators to the first node, and schedule the deep learning task to be executed on at least some of the allocated accelerators. If a plurality of accelerators are not required, it may be determined whether or not the deep learning task is executable in the secondary accelerator (S730).

If the deep learning task is not executable in the secondary accelerator, the primary accelerator of the first node may be determined to be the accelerator to process the deep learning task (S740). If the deep learning task is executable in the secondary accelerator, at least one of the secondary accelerator included in the first node executing the deep learning framework or the secondary accelerator included in the second node connected to the first node through a network may be determined to be the accelerator to process the deep learning task based on the response time of the deep learning task. It may be determined whether or not the response time of the deep learning task is important (S750).

If the response time of the deep learning task is important (e.g., a deep learning task associated with an inference process, and the like), the secondary accelerator included in the first node may be determined to be the accelerator to process the deep learning task (S760). If the response time of the deep learning task is not important (e.g., a deep learning task associated with a training process, and the like), at least some of the plurality of secondary accelerators included in the second node may be determined to be the accelerators to process the deep learning task (S770). In this case, the second node may include one or more nodes.

So far, it has been described that if the deep learning task is executable in the secondary accelerator, at least some of the secondary accelerators included in the first node or the secondary accelerators included in the second node are determined to be the accelerators to process the deep learning task based on the response time, but aspects are not limited thereto. If the deep learning task is executable in the secondary accelerator, among the main accelerator included in the first node, the secondary accelerator included in the first node, and the secondary accelerator included in the second node, the accelerator having the fastest expected response time of the deep learning task may be determined to be the accelerator to execute the corresponding deep learning task.

In another example, if the deep learning task is executable in the secondary accelerator, at least one of the secondary accelerator included in the first node or the secondary accelerator included in the second node may be determined to be the accelerator to process the deep learning task based on stability and/or priority.

If at least some of the plurality of secondary accelerators included in the plurality of second nodes are determined to be the accelerators to process the deep learning task, the deep learning task may be divided into a plurality of partial deep learning tasks by the processor. The input data of the deep learning task may be divided into a plurality of partial input data sets, and the function of the deep learning task and each of the divided plurality of partial input data sets may be allocated to one or more selected secondary accelerators such that the deep learning task may be divided into a plurality of partial deep learning tasks.

According to another example, the parameter data of the deep learning task may be divided into a plurality of partial parameter data sets, and the function of the deep learning task and each of the divided plurality of partial parameter data sets may be allocated to one or more selected secondary accelerators such that the deep learning task may be divided into a plurality of partial deep learning tasks. The divided plurality of partial deep learning tasks may be executed by the processor through the selected secondary accelerators.

FIG. 8 is a flowchart illustrating a method 800 for determining at least one of the primary accelerator or the secondary accelerator. The method 800 for determining at least one of the primary accelerator or the secondary accelerator may be performed by a cluster system for a deep learning cloud service. According to the method 800 for determining at least one of the primary accelerator or the secondary accelerator, prior to determining at least one of the primary accelerator or the secondary accelerator to execute the deep learning task, a step (S810) of determining whether or not a plurality of accelerators is required for the operation of the deep learning task may be initiated.

When executable in a plurality of accelerators, scheduling may be performed so that tasks can be executed in at least some of the actually allocated accelerators (S820). For example, if the number of accelerators allocated to the first node executing the deep learning framework is less than the number of a plurality of accelerators required for the deep learning task, the processor may virtualize the accelerators allocated to the first node to be viewed as a plurality of virtual accelerators and allocate the virtualized plurality of virtual accelerators to the first node, and schedule the deep learning task to be executed on at least some of the allocated accelerators. If a plurality of accelerators are not required, it may be determined whether or not the deep learning task is executable in the secondary accelerator (S830).

If the deep learning task is not executable in the secondary accelerator, the primary accelerator of the first node may be determined to be the accelerator to process the deep learning task (S840). If the deep learning task is executable in the secondary accelerator, the expected execution time of the deep learning task may be compared with a predetermined time (S850). If the expected execution time of the deep learning task is shorter than the predetermined time, the secondary accelerator included in the first node may be determined to be the accelerator to process the deep learning task (S860). If the expected execution time of the deep learning task is longer than the predetermined time, the expected throughput of the deep learning task may be compared with a predetermined throughput (S870).

If the expected throughput of the deep learning task is equal to or less than the predetermined throughput, the processor may determine the secondary accelerator included in the first node to be the accelerator to process the deep learning task (S860). On the other hand, if the expected throughput of the deep learning task is equal to or greater than the predetermined throughput, the processor may determine at least some of the plurality of secondary accelerators included in the second node to be the accelerators to process the deep learning task (S880). In this case, the second node may include one or more nodes.

If at least some of the plurality of secondary accelerators included in the plurality of second nodes are determined to be the accelerators to process the deep learning task, the deep learning task may be divided into a plurality of partial deep learning tasks by the processor. The input data of the deep learning task may be divided into a plurality of partial input data sets, and the function of the deep learning task and each of the divided plurality of partial input data sets may be allocated to one or more selected secondary accelerators such that the deep learning task may be divided into a plurality of partial deep learning tasks.

According to another example, the parameter data of the deep learning task may be divided into a plurality of partial parameter data sets, and the function of the deep learning task and each of the divided plurality of partial parameter data sets may be allocated to one or more selected secondary accelerators such that the deep learning task may be divided into a plurality of partial deep learning tasks. The divided plurality of partial deep learning tasks may be executed by the processor through the selected secondary accelerators.

FIG. 8 illustrates that, after performing the step (S850) of comparing the expected execution time of the deep learning task with the predetermined time, the step (S870) of comparing the expected throughput of the deep learning task with the predetermined throughput is performed, but aspects are not limited thereto. For example, the step (S850) of comparing the expected execution time of the deep learning task with the predetermined time, and the step (S870) of comparing the expected throughput of the deep learning task with the predetermined throughput may be performed in parallel, and respective steps may be performed sequentially in any order.

The method for processing a deep learning task through a deep learning framework in heterogeneous accelerators in the cluster system for the deep learning cloud service described above may be implemented as a computer readable code on a computer readable recording medium. The computer-readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes, and code segments to implement the embodiment(s).

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors. DSPs, ASICs. FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. In addition, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, the present disclosure is not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method comprising:
executing, by a computing device, a deep learning task on a deep learning framework;
determining at least one accelerator of a plurality of accelerators to execute the deep learning task, wherein the plurality of accelerators comprises at least one primary accelerator and at least one secondary accelerator that is heterogeneous to the at least one primary accelerator;
allocating the deep learning task to the determined at least one accelerator; and
generating, based on a result processed by the determined at least one accelerator, result data for the deep learning task.

2. The method according to claim 1, wherein the determining comprises:
determining, from among the at least one primary accelerator and the at least one secondary accelerator, an accelerator to execute the deep learning task, wherein the accelerator to execute the deep learning task is associated with a fastest expected response time for the deep learning task.

3. The method according to claim 1, wherein the determining comprises:
determining whether the deep learning task is executable on the at least one secondary accelerator; and
based on the deep learning task being executable on the at least one secondary accelerator, determining, from among the at least one secondary accelerator, an accelerator to process the deep learning task by selecting at least one of:
a secondary accelerator included in a first node executing the deep learning framework; or
a secondary accelerator included in a second node connected to the first node through a network.

4. The method according to claim 3, wherein the determining an accelerator to process the deep learning task is based on a response time of the deep learning task.

5. The method according to claim 3, wherein the determining an accelerator to process the deep learning task comprises:
based on an expected execution time of the deep learning task being shorter than a predetermined time, determining the secondary accelerator included in the first node to be the accelerator to process the deep learning task.

6. The method according to claim 3, wherein the determining an accelerator to process the deep learning task comprises:
based on an expected throughput of the deep learning task being equal to or less than a predetermined throughput, determining the secondary accelerator included in the first node to be the accelerator to process the deep learning task.

7. The method according to claim 3, wherein the secondary accelerator included in the second node comprises a plurality of secondary accelerators included in the second node, and
wherein the determining an accelerator to process the deep learning task comprises:
based on an expected parameter of the deep learning task satisfying a threshold, dividing the deep learning task into a plurality of partial deep learning tasks; and
determining at least two of the plurality of secondary accelerators included in the second node to be accelerators to process the plurality of partial deep learning tasks.

8. The method according to claim 7, wherein the dividing the deep learning task into a plurality of partial deep learning tasks comprises at least one of:
based on an expected throughput of the deep learning task being equal to or greater than a predetermined throughput, dividing the deep learning task into the plurality of partial deep learning tasks; or
based on an expected execution time of the deep learning task being equal to or longer than a predetermined time, dividing the deep learning task into the plurality of partial deep learning tasks.

9. The method according to claim 7, wherein the allocating the deep learning task comprises:
providing the plurality of partial deep learning tasks to a scheduler that manages the plurality of secondary accelerators included in the second node;
selecting, by the scheduler, one or more executable secondary accelerators from among the plurality of secondary accelerators included in the second node; and
allocating, by the scheduler, the plurality of partial deep learning tasks to the selected one or more executable secondary accelerators.

10. The method according to claim 9, wherein the dividing the deep learning task into a plurality of partial deep learning tasks comprises dividing input data of the deep learning task into a plurality of partial input data sets, and
the allocating the plurality of partial deep learning tasks to the selected one or more executable secondary accelerators comprises allocating a function of the deep learning task and each of the plurality of partial input data sets to the selected one or more executable secondary accelerators.

11. The method according to claim 9, wherein the dividing the deep learning task into a plurality of partial deep learning tasks comprises dividing parameter data of the deep learning task into a plurality of partial parameter data sets, and
the allocating the plurality of partial deep learning tasks to the selected one or more executable secondary accelerators comprises allocating a function of the deep learning task and each of the plurality of partial parameter data sets to the selected one or more executable secondary accelerators.

12. The method according to claim 1, further comprising:
prior to the determining at least one of the plurality of accelerators to execute the deep learning task, determining that an operation of the deep learning task requires a plurality of accelerators; and
based on the operation of the deep learning task requiring a plurality of accelerators and based on a quantity of accelerators allocated to a first node executing the deep learning framework being less than a quantity of the required plurality of accelerators, scheduling at least a portion of the deep learning task for execution on at least one of the accelerators allocated to the first node,
wherein the deep learning task includes scheduling information for the deep learning task scheduled to be executed on the at least one of the accelerators allocated to the first node.

13. A computer-readable medium storing instructions that, when executed by one or more processors, cause:
executing a deep learning task on a deep learning framework;
determining at least one accelerator of a plurality of accelerators to execute the deep learning task, wherein the plurality of accelerators comprises at least one primary accelerator and at least one secondary accelerator that is heterogeneous to the at least one primary accelerator;
allocating the deep learning task to the determined at least one accelerator; and
generating, based on a result processed by the determined at least one accelerator, result data for the deep learning task.

14. The computer-readable medium of claim 13, wherein the instructions, when executed by the one or more processors, cause the determining by:
determining, from among the at least one primary accelerator and the at least one secondary accelerator, an accelerator to execute the deep learning task, wherein the accelerator to execute the deep learning task is associated with a fastest expected response time for the deep learning task.

15. The computer-readable medium of claim 13, wherein the instructions, when executed by the one or more processors, cause the determining by:
determining whether the deep learning task is executable on the at least one secondary accelerator; and
based on the deep learning task being executable on the at least one secondary accelerator, determining, from among the at least one secondary accelerator, an accelerator to process the deep learning task by selecting at least one of:
a secondary accelerator included in a first node executing the deep learning framework; or
a secondary accelerator included in a second node connected to the first node through a network.

16. The computer-readable medium of claim 15, wherein the secondary accelerator included in the second node comprises a plurality of secondary accelerators included in the second node, and
wherein the instructions, when executed by the one or more processors, cause the determining an accelerator to process the deep learning task by:
based on an expected parameter of the deep learning task satisfying a threshold, dividing the deep learning task into a plurality of partial deep learning tasks; and
determining at least two of the plurality of secondary accelerators included in the second node to be accelerators to process the plurality of partial deep learning tasks.

17. The computer-readable medium of claim 16, wherein the instructions, when executed by the one or more processors, cause the dividing the deep learning task into a plurality of partial deep learning tasks by performing at least one of:
based on an expected throughput of the deep learning task being equal to or greater than a predetermined throughput, dividing the deep learning task into the plurality of partial deep learning tasks; or
based on an expected execution time of the deep learning task being equal to or longer than a predetermined time, dividing the deep learning task into the plurality of partial deep learning tasks.

18. The computer-readable medium of claim 16, wherein the instructions, when executed by the one or more processors, cause the allocating the deep learning task by:
providing the plurality of partial deep learning tasks to a scheduler that manages the plurality of secondary accelerators included in the second node;
selecting, by the scheduler, one or more executable secondary accelerators from among the plurality of secondary accelerators included in the second node; and
allocating, by the scheduler, the plurality of partial deep learning tasks to the selected one or more executable secondary accelerators.

19. The computer-readable medium of claim 18, wherein the instructions, when executed by the one or more processors, cause the dividing the deep learning task into a plurality of partial deep learning tasks by dividing input data of the deep learning task into a plurality of partial input data sets, and
wherein the instructions, when executed by the one or more processors, cause the allocating the plurality of partial deep learning tasks to the selected one or more executable secondary accelerators by allocating a function of the deep learning task and each of the plurality of partial input data sets to the selected one or more executable secondary accelerators.

20. The computer-readable medium of claim 13, wherein the instructions, when executed by the one or more processors, further cause:
prior to the determining at least one of the plurality of accelerators to execute the deep learning task, determining that an operation of the deep learning task requires a plurality of accelerators; and
based on the operation of the deep learning task requiring a plurality of accelerators and based on a quantity of accelerators allocated to a first node executing the deep learning framework being less than a quantity of the required plurality of accelerators, scheduling at least a portion of the deep learning task for execution on at least one of the accelerators allocated to the first node,
wherein the deep learning task includes scheduling information for the deep learning task scheduled to be executed on the at least one of the accelerators allocated to the first node.
